(19) United States
(12) Patent Application Publication
(10) Pub. No.: US 2004/0133417 A1
(43) Pub. Date: Jul. 8, 2004

(54) Machine translation of chat room sessions and other collaborative work using session-specific dictionaries

(75) Inventor: Shigeo Azuma, Yokohama-shi (JP)

Correspondence Address: David R. Irvin, IBM Corporation T81/503, PO Box 12195, Research Triangle Park, NC, 27709, US

(73) Assignee: International Business Machines Corporation, Armonk, NY

(21) Appl. No.: 10/726,443

(22) Filed: Dec. 3, 2003

(30) Foreign Application Priority Data
Dec. 13, 2002 (JP) 2002-362879

(51) Int. Cl. G06F 17/20; G06F 15/16

(52) U.S. Cl. 704/8; 709/204

(57) ABSTRACT

A machine translation method for specific words and a translation system using the method. A dictionary management unit for managing a dictionary file referred to in a translation creates a temporary dictionary. The temporary dictionary, which is a virtual dictionary file used in a translation process executed during a session, is created when the session begins. A translation processing unit translates a text by referring to the temporary dictionary and other dictionary files. In this process, the temporary dictionary is referred to in preference to a basic dictionary, a user dictionary, and other resident dictionary files.

### FIELD OF THE INVENTION

The present invention relates to a machine translation technique using a computer, and more particularly to a technique of translating a text and outputting the text using a computer in a multilingual environment.

### BACKGROUND

With the spread of wide-area computer networks such as the Internet, multilingual use of systems is increasing. In particular, a plurality of users may simultaneously use a system with several languages in a chat room, where conversations are carried out in real time, or in collaborative work involving the world wide web. Here, such collaborative work including chat sessions will be generically referred to as collaboration. In these cases, users may communicate with each other by translating messages using a computer. For example, see Japanese Patent Laid-Open No. 2001-109689.

Machine translation is performed with a dictionary file that stores information such as meanings and parts of speech of words, including compound words made up of a plurality of words, and a translation engine that refers to the dictionary file to perform parsing and generate sentences according to predetermined rules. For example, see Japanese Patent Laid-Open No. 2002-108858. The translation engine may be incorporated into an application, for example, an application for supporting the chat system or web collaboration. Alternatively, a translation server with the translation engine and the dictionary file may be provided. This translation capability enables machine translation of texts exchanged during the collaboration.

Nevertheless, today's translation systems have significant limitations. For example, the meaning of a proper noun such as a personal name that is used to represent an object itself may depart from the usual meaning of the noun. Therefore, in translation, a proper noun is preferably rendered as-is to the extent possible, rather than provided with a semantic translation. For characters from other languages that are hard to display or read, for example languages using Chinese characters, it may be necessary to make modifications to a certain extent, such as rendering the characters with English alphabet letters. However, applying a semantic translation of a word so constructed is typically meaningless.

In sessions such as chat room sessions, nicknames called handles or the like may be used as names or symbols for identifying participants. Because these nicknames may also be proper nouns, it is preferable not to translate them. For example, the nickname “SON” used in an original sentence should appear as “SON” in a translated sentence too. Translating it into a word meaning a “son” as a common noun in English could change the meaning of the original sentence.

Such a nickname has the characteristics that it is treated as a proper noun only in a certain sessions such as chat room sessions (temporality) and throughout the session (continuity).

Thus, it is desirable to allow a certain word in sentences to be untranslated or translated in a specific manner. To do this, a possible method is to add a mark, for example a tag in XML (extensible Markup Language) or HTML (Hypertext Markup Language), to the word in sentences in order to prevent the word designated by the mark from being translated.

This method involving the addition of a mark, however, is effective only when the mark added. Therefore, designating a nickname used throughout a session requires adding a mark every time the nickname appears during the session, which complicates input operations.

Further, translating a word such as a personal name or a place name in a specific manner is generally achieved by adding the word to a user dictionary to which a user can add words. A nickname as mentioned-above may then be added to the user dictionary so that it is translated in a specified manner.

However, a dictionary file used in translation generally requires a special format for enabling high-speed access. Therefore, adding a new word requires recompiling the dictionary file after the word has been added. As a result, this method is too demanding for the system, and therefore it is unrealistic to add a nickname that is effective only in a certain session to the user dictionary every time the nickname is set.

In addition, a word such as a nickname may need to be treated as a proper noun only in a certain session, whereas the common meaning of the same word may be needed in other sessions. Therefore, adding a word such as a nickname to the user dictionary involves explicit effort to erase the added word and recompile the user dictionary after completion of the session.

Thus, there is a need for convenient means of providing specific translations for words having temporality and continuity like nicknames used in sessions such as chat sessions.

### SUMMARY

The present invention includes a simple and convenient method for machine-translating certain words in specified manners, and a translation system using the method.

The invention may be implemented as a translation server comprising: a translation processing unit executing a text translation process; and a dictionary storage unit storing a resident dictionary file that is referred to in the translation process executed by the translation processing unit and storing a virtual dictionary file individually created in response to a particular session and temporarily used in the translation process during the session. The virtual dictionary file may be created at the start of the session: and erased at its end. Alternatively, an entry corresponding to the particular session may be registered for the virtual dictionary file at the start of the session and erased from the virtual dictionary file at the end of the session.

The invention may also be implemented as a collaboration server supporting collaborative work performed by exchanging data via a network between a plurality of terminals, comprising: a session management unit for managing a session of collaborative work performed by the plurality of terminals; a translation processing unit for translating a text that has been entered by a terminal into a language used in another terminal; and a dictionary management unit for creating and managing a specific dictionary file for each session managed by the session management unit used by the translation processing unit in the session. If the session managed by the session management unit is a chat session, the session-specific dictionary file corresponding to each new user may be created when the user enters the session and erased when the user exits the session.

The translation server and the collaboration server may be configured not only as a single computer, but also as a system made up of a plurality of computers. In the latter case, for example, the resident dictionary files (a basic or general dictionary, a user dictionary, a specialized dictionary, and the like) and the virtual session-specific dictionary file may be built and used in different computers and external storage devices.

The invention may also be implemented as an information processor (computer) comprising: input means for entering an original text written in a first language; translation processing means for translating the original text into a second language to create a translated text; dictionary storage means for storing a dictionary file referred to in a translation process executed by the translation processing means; virtual dictionary storage means for storing a virtual dictionary file used in the translation process executed by the translation processing means during a session; and output means for outputting the translated text created by the translation processing means.

The invention may also be implemented as a machine translation method of translating a text written in a first language into a second language with a computer, comprising the steps of: creating a specific dictionary file in memory at the start of a session for use in a translation process executed during the session; registering a word that has been entered according to a certain input condition and its usage for the specific dictionary file; and translating the text that has been entered during the session referring to the specific dictionary file. Reference to the specific dictionary file created for each session may be prioritized with respect to a general dictionary and a user dictionary, which may be resident in a storage device such as a hard disk drive.

The invention may also be implemented as a computer program to cause a computer to function as the above-described translation server, collaboration server, or information processor, or alternatively, implemented as a program for causing the computer to execute steps of the above-described machine translation method. The program may be provided in the form of a distributed magnetic disk, an optical disk, semiconductor memory, or other recording media, or distributed over a network.

### BRIEF DESCRIPTION OF THE DRAWINGS

FIG. 1 shows an exemplary configuration of a multilingual collaboration system including a translation server according to an exemplary embodiment of the invention.

FIG. 2 schematically shows an exemplary hardware configuration of a computer that implements a translation system according to an exemplary embodiment of the invention.

FIG. 3 shows a functional configuration of the translation system according to an exemplary embodiment of the invention.

FIG. 4 is a flowchart describing an operational flow of collaboration including a translation operation according to an exemplary embodiment of the invention.

FIG. 5 shows an exemplary configuration in which a collaboration server itself has functions of the translation system according to an exemplary embodiment of the invention.

FIG. 6 shows an exemplary configuration in which the translation system according to an exemplary embodiment of the invention is provided as a function of an information processing system.

### DETAILED DESCRIPTION

Now, the present invention will be described in detail with reference to exemplary embodiments illustrated in the appended drawings.

An exemplary embodiment will be described with respect to a translation system translating texts such as messages exchanged in individual sessions of multilingual collaboration. The translation system may be introduced into a collaboration server on a network as a function of an application that supports the collaboration. Alternatively, the translation system may be independently constructed on a network as a translation server used by the collaboration server. The translation system may also be introduced as a function of a terminal that is connected to a network and that performs actual activities (input/output) in the collaboration. By way of example, the following description will be given for a translation server independently constructed on a network.

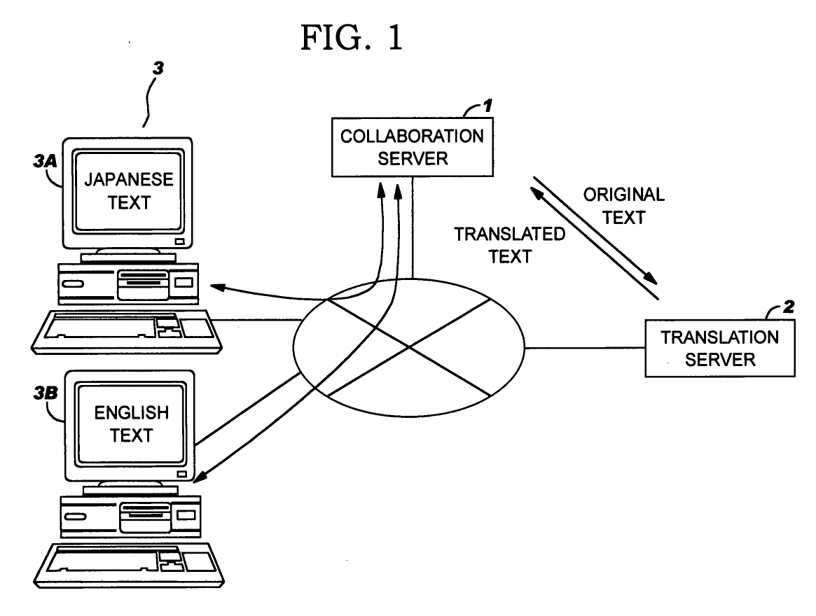

In FIG. 1, connected to a network are a collaboration server 1, a translation server 2, and a plurality of terminals 3. Users operate respective terminals 3 (3A, 3B) to perform collaborative work such as chat room sessions or web collaborations. The collaboration server 1 supports the collaboration performed with the terminals 3. That is, the collaboration server 1 causes the terminals 3 participating in a session of the collaboration to display a common screen so that activities (operations) performed on one terminal 3 are reflected on the display screen (output) of the other terminal 3 as well.

Here, suppose that the terminals 3 use different languages during the session. For example, the user of the terminal 3A works in Japanese, whereas the user of the terminal 3B works in English. The languages used may be registered with the collaboration server 1 upon initiation of the session.

Then, the collaboration server 1 translates a Japanese text that has been entered on the terminal 3A into an English text using the translation server 2, and causes the terminal 3B to output the translated text. Similarly, it translates an English text that has been entered on the terminal 3B into a Japanese text using the translation server 2, and causes the terminal 3A to output the translated text.

The translation server 2 receives input of user management information about the terminals participating in the session such as login information (IDs), languages, and so forth, a text to be translated, and information that specifies the translation direction, for example whether from Japanese into English or from English into Japanese, from the collaboration server 1. The translation server 2 then translates the entered text (original text) and returns a generated text (translated text) to the collaboration server 1.

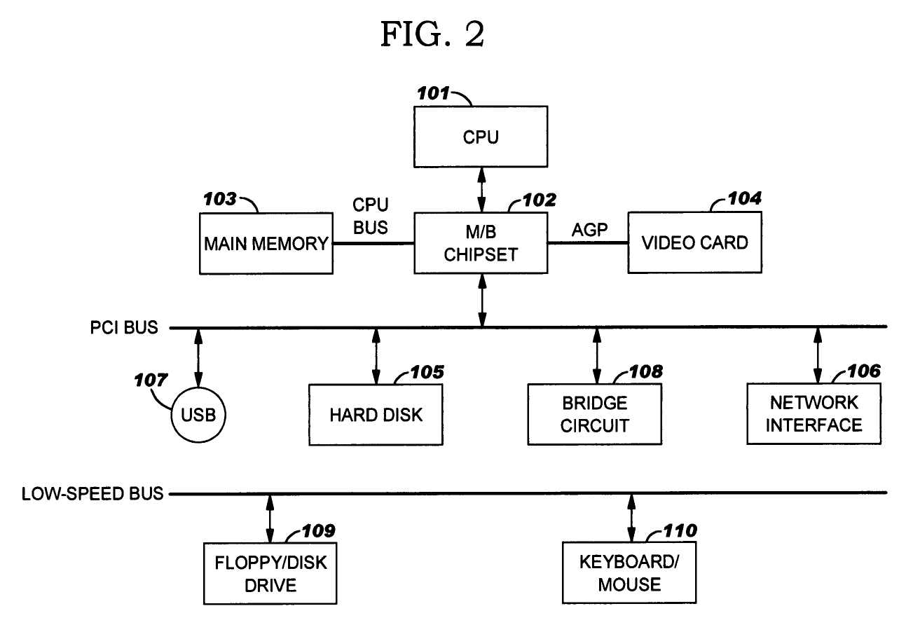

The exemplary computer shown in FIG. 2 includes a CPU (Central Processing Unit) 101 as operation means; main memory 103 connected to the CPU 101 via a M/B (motherboard) chipset 102 and a CPU bus; a video card 104 also connected to the CPU 101 via the M/B chipset 102 and an AGP (Accelerated Graphics Port); a hard disk 105, a network interface 106, and a USB port 107 connected to the M/B chipset 102 via a PCI (Peripheral Component Interconnect) bus; and a floppy disk drive 109 and a keyboard/mouse 110 connected to the M/B chipset 102 via the PCI bus, a bridge circuit 108, and a low-speed bus such as an ISA (Industry Standard Architecture) bus.

FIG. 2 is an illustration of an exemplary hardware configuration of a computer that is suitable for implementing this embodiment; various other configurations are possible as well. For example, the computer may be provided with just video memory instead of the video card 104, in which case the CPU 101 processes image data. The computer may also be provided with a CD-ROM (Compact Disc Read Only Memory) drive or a DVD-ROM (Digital Versatile Disc Read Only Memory) drive via an interface such as ATA (AT Attachment).

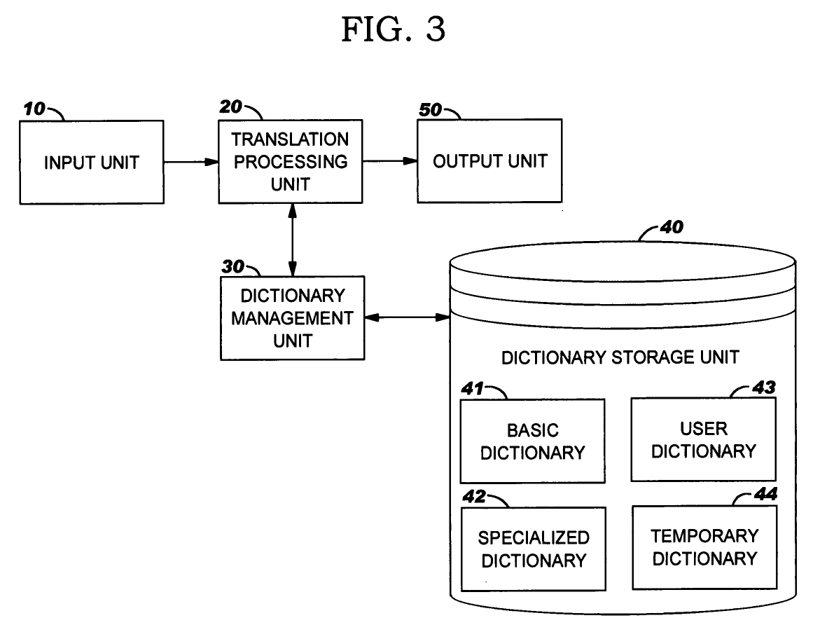

Now with reference to FIG. 3, the translation system in this embodiment includes an input unit 10 for entering an original text to be translated; a translation processing unit 20 for translating the original text that is entered using the input unit 10 and for generating a translated text; a dictionary management unit 30 and a dictionary storage unit 40 for managing dictionaries used in the translation process of the translation processing unit 20; and an output unit 50 for outputting the translated text generated by the translation processing unit 20.

In this configuration, the translation processing unit 20 and the dictionary management unit 30 may be implemented in, for example, the program-controlled CPU 101 in the translation server 2. The program for controlling the CPU 101 may be provided in the form of a distributed magnetic disk, optical disk, semiconductor memory, or other recording media, or distributed over a network. For the computer shown in FIG. 2, the program may be stored (installed) on the hard disk 105, loaded into the main memory 103, and expanded. The program then controls the CPU 101 and causes it to function as the translation processing unit 20 and the dictionary management unit 30.

The dictionary storage unit 40 may be implemented in, for example, the main memory 103 or the hard disk 105 shown in FIG. 2. The dictionary storage unit 40 may include a basic or general dictionary 41, a specialized dictionary 42, and a user dictionary 43, all of which may be resident in the dictionary storage unit 40, as well as a temporary or session-specific dictionary 44 created as needed. Details of these dictionary files will be given later.

Because this exemplary embodiment addresses a translation server 2 constructed on a network, the original text may be entered from the collaboration server 1 via the network interface 106. However, the input unit 10 may be any of other various input devices, such as the keyboard/mouse 110 shown in FIG. 2, a character recognition device, a voice recognition device, and the like.

Also, in this embodiment, the generated translated text is transmitted to the collaboration server 1 via the network interface 106, as is the original text. However, the output unit 50 may be any of other various output devices, such as a display device, a printer, a voice synthesizer that reads aloud the translated text, and the like.

FIG. 3 is an exemplary illustration of a functional configuration of the translation system and does not limit the hardware configuration that may be used to implement the translation system. For example, although FIG. 3 shows one dictionary storage unit 40 storing several dictionaries (basic dictionary 41, specialized dictionary 42, user dictionary 43, and temporary dictionary 44) for functional reasons, these dictionaries may be built and used in a plurality of computers or external storage devices such as hard disks, DVDs, CD-ROMs, and the like.

Now, each of these functions will be further described.

The translation processing unit 20 performs various analyses on an original text to be translated, such as a morphemic analysis and a syntactic analysis. It refers to the dictionary files stored in the dictionary storage unit 40 and generates a translated text based on predetermined rules. An existing translation engine may be used as the translation processing unit 20.

The dictionary management unit 30 determines which dictionary file to refer to in the processing of the translation processing unit 20. It may also create the temporary dictionary 44 in the dictionary storage unit 40. The temporary dictionary 44 may be created in, for example, the main memory 103 shown in FIG. 2.

As described above, the dictionary storage unit 40 stores resident dictionary files such as the basic dictionary 41, specialized dictionary 42, and user dictionary 43, as well as the temporary dictionary 44 created by the dictionary management unit 30. The basic dictionary 41 is a dictionary file that contains general words, and may include compound words. The specialized dictionary 42 is a dictionary file that contains words used in a specialized field. Several specialized dictionaries may be provided for respective predetermined specialized fields, or a single specialized dictionary may be partitioned for several specialized fields. The user dictionary 43 is a dictionary containing words provided explicitly by a user or learned from entered text. The temporary dictionary 44 is a temporary and virtual dictionary file created for each session of collaboration such as a chat, and it contains words to be translated in a specific manner and their translation (usage) in that session.

The dictionary management unit 30 switches among these dictionary files so that the translation processing unit 20 refers to them in the following order of priority: the temporary dictionary 44, the user dictionary 43, the basic dictionary 41, and the specialized dictionary 42. When a document of a specific specialized field is translated, the specialized dictionary 42 of that field may have higher priority than the basic dictionary 41.

Now, the temporary (session-specific) dictionary 44 will be described further in detail.

When collaboration such as a chat is conducted in a multilingual environment, a text that has been entered on one terminal 3 is translated into the language used in the other terminal 3 and is output on the other terminal 3. When a plurality of other terminals 3 exist and a plurality of languages are used, the text is translated into the languages used in the respective terminals 3. In a collaborative session, proper nouns effective only for the duration of that session, such as handles (nicknames) of users, may be used. If the temporary dictionary 44 does not exist, such proper nouns will be given established translations with reference to the user dictionary 43, the basic dictionary 41, or the specialized dictionary 42. However, because such proper nouns are used in a special way during the session, the resulting sentences may not make sense with the established translations.

The following examples illustrate this problem.

Japanese users may use Anglicized forms of their names or parts of their names as handles. For example, Takeda and Takeshi may use a handle of “Take” from the pronunciations of their names, Hidetoshi and Hideo may use a handle of “Hide,” and so on. Of course, the word “take” in its ordinary English usage has meanings such as “reach out and hold” and “go away with.” In this light, consider the sentence containing a vocative word for “Take”—“Take, you win.” This sentence should be translated into Japanese having the meaning “Take (vocative), you win”. However, it may well be translated as “You take where you win,” which makes no sense.

Similarly, the word “hide” in English has meanings such as “skin” and “conceal.” Consider, then, sentences containing a vocative word for “Hide,” such as the sentences “Hide, do you quit now?” And “Hide, shoot or run.” These sentences should be translated into Japanese with the meaning “Hide (vocative), do you quit now?” and “Hide (vocative), shoot or run,” respectively. However, they may well be translated as “Skin, do you quit now?” and “Conceal yourself, shoot or run,” which depart from the intentions of the user.

In addition to the mistranslation of nicknames, another possible mistranslation in a multilingual environment results from the existence of words with the same spelling but different meanings in English, French, German, and so on. For example, “chat” means “talk” in English but “cat” in French, “fin” means “external membranous process of fish” in English and “finish” in French, “pain” means “hurt” in English and “bread” in French, “boot” means “shoes that cover one's foot and the lower part of one's leg” in English and “boat” in German, “kind” means “obliging” in English and “child” in German, “tag” means “label” in English and “day” in German, “rot” means “decay” in English and “red” in German, and so on. If a sentence containing such a word with its English meaning is translated into English and French or into English and German in the usual manner, the resulting translated texts in French and German will have different meanings from the English text.

When one wishes to use such troublesome words in a specific manner, in particular using them as-is for nicknames or using them with their English meanings, the standard manner of translation will lead to errors in meaning. To circumvent this problem, the present invention introduces the temporary dictionary 44 which may be configured with such words and their usage. Reference to the temporary dictionary 44 may be prioritized over other dictionaries. This enables proper translation of the troublesome words. Because the temporary dictionary 44 is created for each collaborative session as described above, special usage for only that session may be defined; that is, this usage does not affect other sessions. Further, because translation is performed with reference to the temporary dictionary 44 throughout the session, using a word in a special manner does not require any special operations, such as adding a tag, for each use.

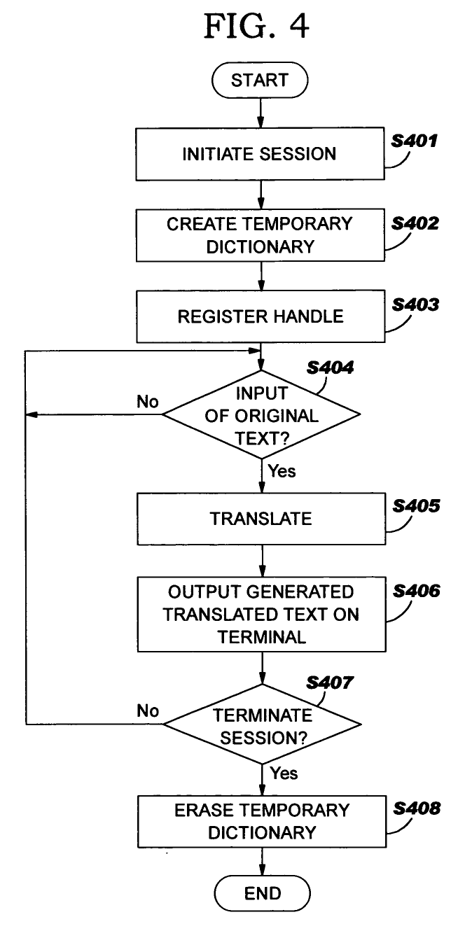

Now with reference to FIG. 4, a collaborative session is first initiated (step 401). At this point, user management information, such as login information and a language to be used, may be registered with the collaboration server 1. If the collaboration is a chat, a session is initiated when a user enters a site often called a chat room managed by a chat system. So, in this example, the user management information is registered at this entry point.

Once the user management information has been registered with the collaboration server 1, the user management information is transmitted to the translation server 2. The dictionary management unit 30 then creates a temporary session-specific dictionary 44 (step 402). A handle (nickname) for the user participating in the session is added to the temporary dictionary 44 (step 403). Words may be added to the temporary dictionary 44 at any time during the session by a predetermined addition operation. For a chat, a session is initiated each time a user enters the chat room as mentioned before, so that the temporary dictionary 44 is created for each user.

After initiation of the session, when an original text is entered on a terminal 3 participating in the session (step 404), the collaboration server 1 transmits the original text and information indicating the translation direction to the translation server 2 in order to request translation. The translation processing unit 20 in the translation server 2 translates the original text into a language registered by a user of the other terminal 3 participating in the session (step 405). In this translation, reference to the temporary dictionary 44 is given the highest priority, under the control of the dictionary management unit 30. Therefore, the handle for the user, and words individually stored in the temporary dictionary 44, are translated in a specific manner according to the content of the temporary dictionary 44, including the case where they are rendered as-is, i.e., untranslated.

The translated text generated by the translation processing unit 20 is transmitted from the translation server 2 to the collaboration server 1. Under the control of the collaboration server 1, the translated text is reflected in the output (such as on the work screen) of the terminal 3 of the other participant in the session (step 406).

The session proceeds by repeating the steps 404 through 406 (step 407).

Upon termination of the session, the dictionary management unit 30 in the translation server 2 erases the temporary dictionary 44 used in the session (step 407, 408). When a user exits the chat room, the temporary dictionary 44 for the user is erased.

In the above exemplary operation, words explicitly added to the temporary dictionary 44, such as words that are entered as handles, are translated in a specific manner according to the added content. It is also possible, however, to derive words such as nicknames from the way the entered texts are displayed, for example during a chat, and to learn the words, i.e., to add the words automatically to the temporary dictionary 44. For example, a word rendered by all capital alphabet letters may be added to the temporary dictionary 44.

In the above exemplary operation, a new temporary dictionary 44 is created at the start of a session and erased at the end of the session. It is also possible, however, that the temporary dictionary 44 resides in the main memory 103, and an entry for a session is added at the start of the session and erased at the end of the session. In this case, again, translation based on an entry for a certain session is prioritized during that session.

The above embodiment has been described for the case wherein the independent translation server 2 is provided on a network and a text that has been entered in a collaborative session is translated as requested by the collaboration server 1. The present invention, however, may be used with various other configurations as well.

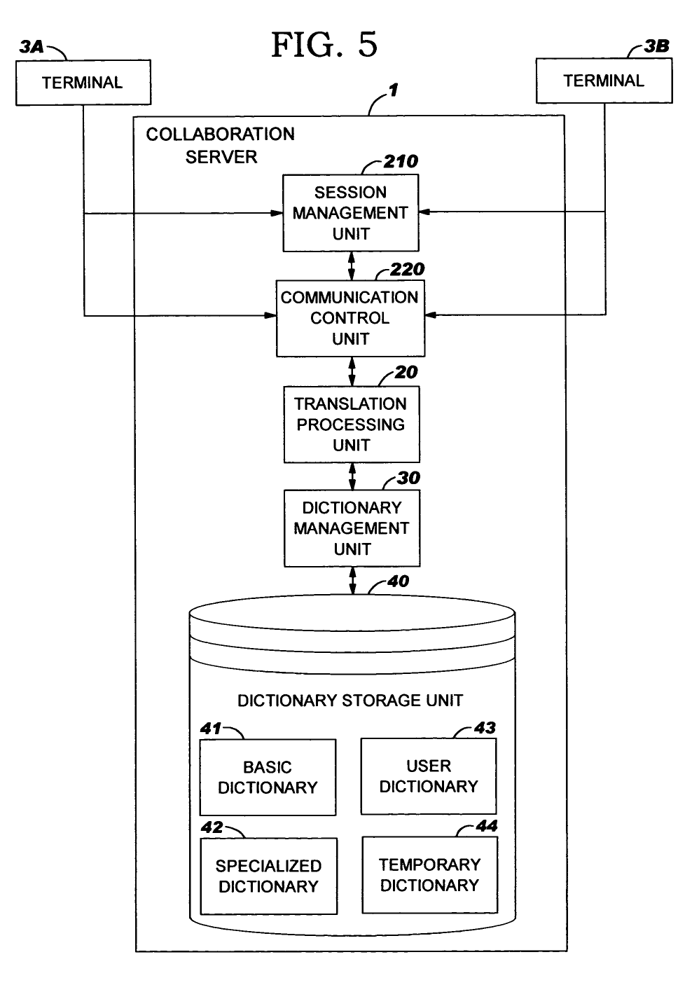

For example, the collaboration server 1 in FIG. 5 includes a session management unit 210 for managing a session of collaboration performed by a plurality of terminals 3 that exchange data over a network, and a communication control unit 220 allowing activities (operations) performed on one terminal 3 to be reflected on a display screen (output) of the other terminal 3. The collaboration server 1 further includes the translation processing unit 20, the dictionary management unit 30, and the dictionary storage unit 40, similar to the functions of the translation server 2 in the above described embodiment. As with the translation server 2, the collaboration server 1 may be implemented in, for example, the computer shown in FIG. 2. Then, the session management unit 210 and the communication control unit 220 may be implemented in the programmed CPU 101, as with the translation processing unit 20 and the dictionary management unit 30.

FIG. 5 is an exemplary illustration of a functional configuration of the collaboration server 1 having the functions of the translation system according to this embodiment. The invention applies as well to other configurations. For example, although FIG. 5 shows one dictionary storage unit 40 storing several dictionary files for functional reasons, these dictionary files may be built and used in a plurality of computers or external storage devices.

The communication control unit 220 passes a text that has been entered in communication between the terminals 3 to the translation processing unit 20 so that the text is translated into a language used in the destination terminal 3. With the start of each collaborative session managed by the session management unit 210, the dictionary management unit 30 creates the temporary dictionary 44 for the session. The translation processing unit 20 accesses the various dictionary files in the dictionary storage unit 40 via the dictionary management unit 30 to perform translation processing.

In this configuration, the communication control unit 220 passes texts and necessary information to the translation processing unit 20 as needed. Therefore, in the interest of simplicity, the input unit 10 and the output unit 50 have been omitted in FIG. 5.

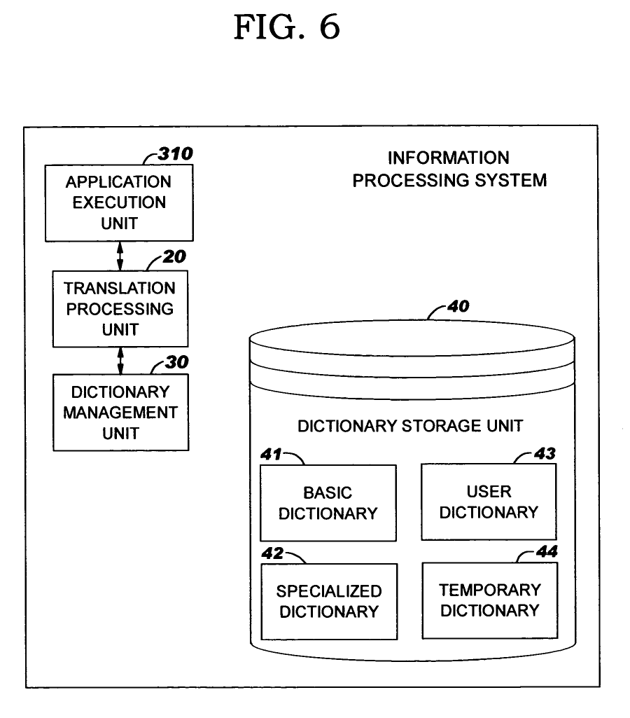

The present invention is not limited to network services such as collaboration, but may be implemented as well as a translation function used for information processing in various information processing systems using a computer. FIG. 6 shows an exemplary configuration in which the translation system is provided as a function of an information processing system.

As shown in FIG. 6, the information processing system includes an application execution unit 310 for performing predetermined information processing, as well as the translation processing unit 20, the dictionary management unit 30, and the dictionary storage unit 40, similar to the functions of the translation server 2 in the above described embodiment. As with the above described translation server 2, the information processing system is implemented in the computer shown in FIG. 2, for example. Then, the application execution unit 310 is implemented in the programmed CPU 101, as with the translation processing unit 20 and the dictionary management unit 30.

FIG. 6 is an exemplary illustration. The invention applies as well to other configurations. For example, although FIG. 6 shows one dictionary storage unit 40 storing several dictionary files for functional reasons, these dictionary files may be built and used in a plurality of computers or external storage devices.

The application execution unit 310 executes predetermined information processing according to an application program. It passes an entered text received during the information processing to the translation processing unit 20 so that the text is translated into a language used in the terminal 3 of the system. With the start of execution of the application program or execution of certain work in the information processing, the dictionary management unit 30 creates the temporary dictionary 44 for the work. The translation processing unit 20 accesses the various dictionary files in the dictionary storage unit 40 via the dictionary management unit 30 to perform translation processing.

In this configuration, the application execution unit 310 passes texts and necessary information to the translation processing unit 20 as needed. Therefore, in the interest of simplicity, the input unit 10 and the output unit 50 have been omitted in FIG. 6.

The present invention may also be provided as the dictionary management unit 30, or as a program for the computer to cause the computer to function as the dictionary management unit 30, referred to as a dictionary management program hereafter. That is, the dictionary management program is installed on a system such as a translation server and various types of information processing systems, having a translation engine (translation processing unit 20) and a storage device (dictionary storage unit 40) storing dictionary files to support the translation engine. Thus, the temporary dictionary 44 may be created at the start of a session, and reference to the temporary dictionary 44 is prioritized over other dictionaries in execution of translation. The created temporary dictionary 44 may be erased at the end of the session that caused the creation thereof.

I claim:

1. A translation server for translating an entered text and providing a translated text, comprising:
a translation processing unit for executing a text translation process; and
a dictionary storage unit for storing a general dictionary file referred to in the text translation process and a virtual dictionary file created for a session and temporarily used in the text translation process during the session.

2. The translation server according to claim 1, wherein the virtual dictionary file stored in the dictionary storage unit is created when the session begins and erased when the session ends.

3. A collaboration server for supporting a collaborative session with a plurality of terminals exchanging data via a network, comprising:
a session management unit for managing a session of collaborative work with the plurality of terminals;
a translation processing unit for translating a text in a first language entered during the session with a first terminal into a second language used in a second terminal participating in the session; and
a dictionary management unit for creating and managing a session-specific dictionary file used by the translation processing unit during the session.

4. The collaboration server according to claim 3, wherein the dictionary management unit creates the session-specific dictionary when the session starts and erases the session-specific dictionary file when the session ends.

5. The collaboration server according to claim 3, wherein the dictionary management unit creates a session-specific dictionary file for each terminal participating in the session.

6. The collaboration server according to claim 3, wherein if the session is a chat session, the dictionary management unit creates a session-specific dictionary file corresponding to a user when the user enters the chat and erases the session-specific dictionary file when the user exits the chat.

7. An information processor, comprising:
input means for entering a text described in a first language;
translation processing means for translating the text into a second language to create a translation text;
dictionary storage means for storing a general dictionary file referred to in the translation process executed by the translation processing means;
virtual dictionary storage means for storing a virtual dictionary file used in the translation process executed by the translation processing means during a session; and
output means for outputting the translation text created by the translation processing means.

8. The information processor according to claim 7, wherein the virtual dictionary file stored in the virtual dictionary storage means is created with specificity to the session.

9. The information processor according to claim 7, wherein the virtual dictionary file stored in the virtual dictionary storage means is created at the start of the session and erased at the end of the session.

10. A machine translation method for translating a text described in a first language into a second language with a computer, comprising the steps of:
creating, in a memory, when a session starts, a dictionary file used in a translation process executed during the session, the dictionary file being specific to the session;
registering a word and its usage in the dictionary file specific to the session; and
translating text entered during the session referring to the dictionary file specific to the session.

11. The machine translation method according to claim 10, wherein the step of translating gives higher priority to the dictionary file specific to the session than to a general dictionary file.

12. The machine translation method according to claim 10, further comprising the step of erasing the dictionary file specific to the session when the session ends.

13. A computer program product for causing a computer to perform method steps for translating a text described in a first language into a second language, said method steps comprising:
creating, in a memory, when a session begins, a dictionary file specific to the session, used in a translation process executed during the session;
registering a word and its usage in the dictionary file specific to the session; and
translating text entered during the session, referring to the dictionary file specific to the session created when the session starts.

14. The computer program product according to claim 13, wherein the method steps further comprise the step of erasing the dictionary file specific to the session when the session ends.

15. A computer program product for causing a computer to execute method steps for translating a text described in a first language into a second language, said method steps comprising:
creating, in a memory, when a session begins, a dictionary file specific to the session used in a translation process executed during the session;
registering a word and its usage in the dictionary file specific to the session;
referring to the dictionary file that is specific to the session with higher priority than a general dictionary file when translating text entered during the session; and
erasing the dictionary file specific to the session when the session ends.

16. A computer program product for causing a computer to execute method steps for supporting collaborative work with a plurality of terminals exchanging data via the network, said method steps comprising:
reflecting work conducted by a first terminal on an output of a second terminal during a session;
translating a text entered in the first terminal using a first language into a second language used in the second terminal; and
creating and managing a dictionary file used in the step of translating, wherein the dictionary file is specific to the session.

17. The program product according to claim 16, wherein the dictionary file specific to the session is created at the beginning of the session and erased at the end of the session.

18. A computer program product for causing a computer connected to a network to execute method steps for providing a chat system, said method steps comprising:
translating a text entered in a first terminal participating in a chat into a language used in a second terminal participating in the chat;
copying, by a third terminal that enters the chat, a session-specific dictionary file used in translating the text; and
erasing the session-specific dictionary file from the third terminal when the third terminal leaves the chat.
